(19) United States
(12) Patent Application Publication
(10) Pub. No.: US 2006/0014508 A1
(43) Pub. Date: Jan. 19, 2006

(54) Device and method for determining the level of an input signal intended to be applied to a receiving system

(76) Inventors: Francois Seneschal, Caen (FR); Alexandre Maupas, Bois-Guillaume (FR)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/528,739

(22) PCT Filed: Sep. 15, 2003
(86) PCT No.: PCT/IB03/04054

§ 371 Date: Mar. 22, 2005

(30) Foreign Application Priority Data
Sep. 25, 2002 (FR) 0211838

(51) Int. Cl. H04B 1/06; H04B 7/00

(52) U.S. Cl. 455/253.2

(57) ABSTRACT

The invention relates to a device for determining the level of an input signal (101) intended to be applied to a receiving system (TUN), said receiving system (TUN) comprising arranged in series a set of discrete gain amplifiers (102-103-105-107), a selective filter (104), a mixer (106), said receiving system (TUN) being intended to deliver an output signal (108), said device comprising: measuring means (116) for measuring the level of said output signal (108) in a given frequency channel, means (120) for determining the real gain (G1) of said set of amplifiers (102-103-105-107) in said given frequency channel, means (121) for determining the real gain (G2) of said selective filter (104) in said given frequency channel, calculation means (122) for deriving the level of the input signal (101) from the level of the output signal (108), the real gain (G1) of said set of amplifiers (102-103-105-107) and from the real gain (G2) of said selective filter (104).

### FIELD OF THE INVENTION

The invention relates to a device for determining the level of an input signal intended to be applied to a receiving system, said receiving system comprising arranged in series a set of discrete gain amplifiers, a selective filter, a mixer, said receiving system being intended to deliver an output signal.

The invention has numerous applications in appliances intended to receive a radio-frequency signal (RF) whose level is to be determined.

### BACKGROUND OF THE INVENTION

The development of cable networks implies to establish a fast diagnosis of installations of which the service providers are in charge and in control.

In order to be able to rapidly verify the cable system at the level of each user, that is to say, at the level of the receiving systems, the receiving systems (for example a so-called set top box or cable modem comprising a tuner) are to have the RSSI functionality (Received Signal Strength Indicator) in conformity with American standard DOCSIS V1.1.

This functionality allows determining with an absolute precision of ±3 dB and a relative precision of ±0.5 dB (relative to a signal of known level sent by the service provider), the level of the input signal which is applied to the receiving system.

Once the level of the input signal has been determined, it is sent to the service provider to perform a diagnostic.

From the state of the art are known devices for determining the level of an input signal intended to be applied to a receiving system. These devices implement calibration tables stored in a memory defining the characteristic features of all the components used.

These known devices have a certain number of limitations in so far as the calibration tables are to be recalculated for each component, which renders the manufacture of such devices costly, considering the time necessary for the calibration.

On the other hand, these tables store many data, which implies that an additional memory of the EPROM type is used, which increases the cost price and the size of the device.

Finally, at the end of the manufacturing process, these devices are often not compliant with the DOCSIS V1.1 standard because they do not respect the precision of the input signal that is determined. A costly selection from all these devices is thus to be made to select only the compliant devices.

### OBJECT AND SUMMARY OF THE INVENTION

It is an object of the invention to propose a low-cost device which is in conformity with the DOCSIS standard for determining the level of an input signal intended to be applied to a receiving system.

To this end, the device according to the invention comprises:

measuring means for measuring the level of said output signal in a given frequency channel,
means for determining the real gain of said set of amplifiers in said given frequency channel,
means for determining the real gain of said selective filter in said given frequency channel,
calculation means for deriving the level of the input signal from the level of the output signal, the real gain of said set of amplifiers and from the real gain of said selective filter.

The device measures an output signal in the desired frequency channel and determines the total gain of both amplifiers and selective filter. When the level of the output signal and the gain is expressed in Decibels (dB), the level of the input signal is simply derived by a subtraction between the output signal level and said total gain, which constitutes a cost-effective solution.

In a preferred embodiment, the real gain of said selective filter is given by a set of equations defined by a set of coefficients depending on said frequency channel.

A few coefficients are used for defining the equations, which permits to store them no longer in a specific memory of the EPROM type but in the general memory of the receiving system.

In a preferred embodiment, the device according to the invention comprises additional means for averaging the level of said output signal.

This additional characteristic allows decreasing the noise contained in the output signal, which permits to precisely determine the level of the input signal.

In a preferred embodiment, the device according to the invention comprises additional means for rounding the level of said input signal to the nearest half value.

This additional characteristic permits to statistically enhance the precision of the level of the input signal and thus to reduce the measuring error.

In a preferred embodiment, the real gain of said set of amplifiers is given by a look-up table with two inputs, a first input corresponding to said given frequency channel, a second input corresponding to the nominal gain of said amplifiers.

The look-up table permits to know the real gain of each amplifier, which permits to precisely derive the level of the input signal.

The number of coefficients stored in the look-up table is limited, which permits to store them no longer in a specific EPROM-type memory but in the memory of the receiving system.

In a preferred embodiment, said measuring means comprise arranged in series a selective filter for selecting said given frequency channel, a logarithmic detector and an analog-to-digital converter for delivering the level of said output signal in said given frequency channel.

This additional characteristic allows generating a digital value of the output signal level which is expressed in Decibels, which value can directly be used for determining the level of the input signal.

The invention also relates to a method for determining, in accordance with the DOCSIS standard, the level of an input signal intended to be applied to a receiving system. For this purpose the steps of this method correspond to the functions of the various processing means used in the device according to the invention described earlier.

The invention also relates to a receiving system of the multimedia signal set-top box type or the modem type comprising a tuner, the receiving system comprising a device as described earlier for determining the level of the input signal applied to its input.

The invention also relates to a signal generated by the device or the method according to the invention. This signal corresponds to the determined level of the input signal, and implicitly comprises technical characteristics of said device and method.

The invention also relates to a computer program product comprising instruction codes for implementing one or a plurality of steps of the method mentioned above. These instruction codes are intended to be stored in a memory and executed by a signal processor.

### BRIEF DESCRIPTION OF THE DRAWINGS

These and other aspects of the invention are apparent from and will be elucidated, by way of non-limitative example, with reference to the embodiment(s) described hereinafter. In the drawings:

FIG. 1 describes a receiving system comprising a device in accordance with the invention,

FIG. 2 represents the flow chart of the steps of the method according to the invention,

FIG. 3 illustrates the gain variations of a selective filter.

### DETAILED DESCRIPTION OF THE INVENTION

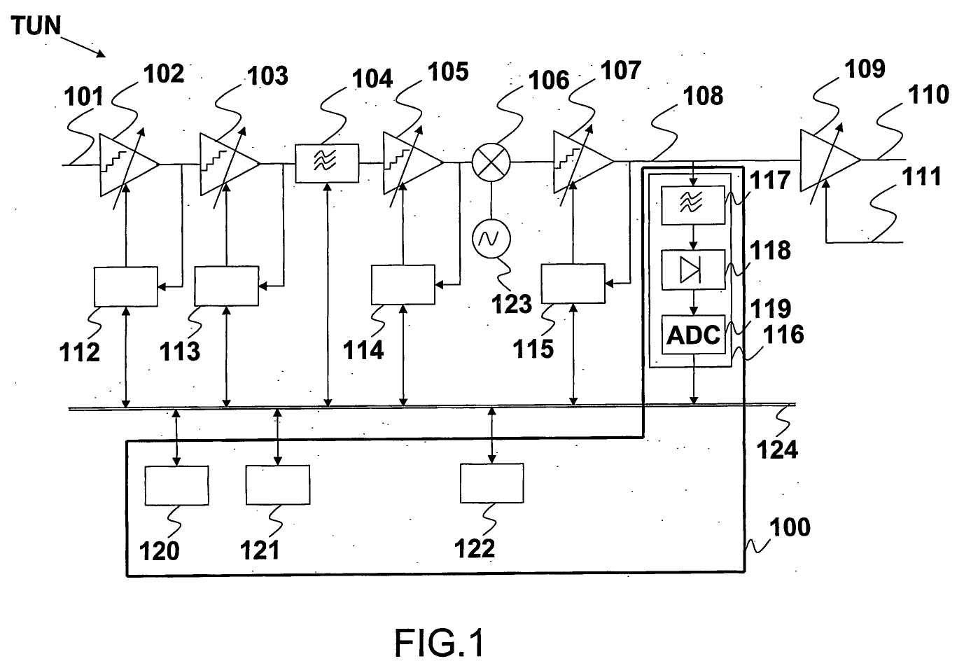

FIG. 1 describes a receiving system comprising a tuner TUN, and a device 100 according to the invention. The receiving system receives on its input a radio-frequency (RF) signal 101 whose level for a given frequency channel is determined by the device 100 according to the invention. The receiving system comprises arranged in series:
an amplifier 102 receiving the input signal 101, whose nominal gain is defined by a control device 112 via the sending of a digital control word,
an amplifier 103 whose nominal gain is defined by a control device 113 via the sending of a digital control word,
a selective filter 104 intended to suppress high-order harmonics in the input signal 101,
an amplifier 105 whose nominal gain is defined by a control device 114 via the sending of a digital control word,
a mixer 106 for performing a frequency change in the amplified input signal 101 via a multiplication of a periodic signal coming from an oscillator 123,
an amplifier 107 delivering an output signal 108 whose nominal gain is defined by a control device 115 via the sending of a digital control word,
an amplifier 109 delivering ‘an output ’ signal 110 of a constant level, whose gain is defined by a control signal 111.

The device 100 according to the invention is connected to the receiving system via a data bus 124, for example an I²C bus. The device 100 comprises:
measuring means 116 for measuring the level of said output signal 108 in a given frequency channel,
means 120 for determining the cumulated gain of the amplifiers 102-103-105-107 in said given frequency channel,
means 121 for determining the gain of said selective filter 104 in said given frequency channel,
calculation means 122 for deriving said level of the input signal 101 from said output signal 108, from the cumulated gain of the amplifiers 102-103-105-107 and from the gain of said selective filter 104.

The measuring means 116 and processing means 120-121-122 communicate over the data bus 124.

The working principle of the device 100 is to measure the level of the output signal 108, to determine the real total gain via which the input signal 101 is amplified by the various amplifiers and filters arranged in series, and to derive the level of the input signal 101 from these values.

The real total gain via which the input signal 101 is amplified by the amplifiers 102-103-105-107 is given by a dual-input look-up table, a first input corresponding to the given frequency channel X, a second input corresponding to the nominal gain of said amplifiers. A non-limitative example of such a look-up table is given below:

| | AGC1 (dB) | | | AGC2 (dB) | | | | | | AGC3 (dB) | | | AGC4 (dB) | | |
|---|---|---|---|---|---|---|---|---|---|---|---|---|---|---|---|
| F (MHz) | 4 | 8 | 12 | −6 | −2 | 2 | 6 | 10 | 14 | −8 | −4 | 0 | −6 | −3 | 0 |
| 0 < X < 420 | 4.1 | 8.1 | 12 | −5.7 | −1.7 | 2.3 | 6.3 | 10.2 | 14 | −7.8 | −3.8 | 0 | −5.8 | −2.9 | 0 |
| 420 < X < 840 | 3.9 | 7.9 | 12 | −5.9 | −2 | 2 | 6.2 | 10.1 | 14 | −7.7 | −3.9 | 0 | −5.8 | −2.9 | 0 |
| X > 840 | 4.5 | 8.2 | 12 | −4.8 | −1 | 2.9 | 6.9 | 10.7 | 14 | −7.3 | −3.5 | 0 | −5.8 | −2.9 | 0 |

The parameter X corresponds to the frequency channel for which the input signal is determined by the device 100 according to the invention. The first row of the columns AGC1-AGC2-AGC3-AGC4 corresponds to the nominal gains of the amplifiers 102-103-105-107, fixed by the control devices 112-113-14-115, respectively.

The values of these nominal gains are sent to the means 120 by each of the amplifiers over the data bus 124. For each amplifier, the means 120 are in charge of putting the value of a nominal gain and the frequency channel X into correspondence for determining the real gain of the amplifier, said real gain being given by the coefficients of the dual-input look-up table. The coefficients of the look-up table are derived from a calibration previously carried out on each amplifier, and then stored in a memory (not shown).

Once the real gain of each amplifier is known, a sum of these real gains is done by the means 120 to determine the total gain of the set of amplifiers.

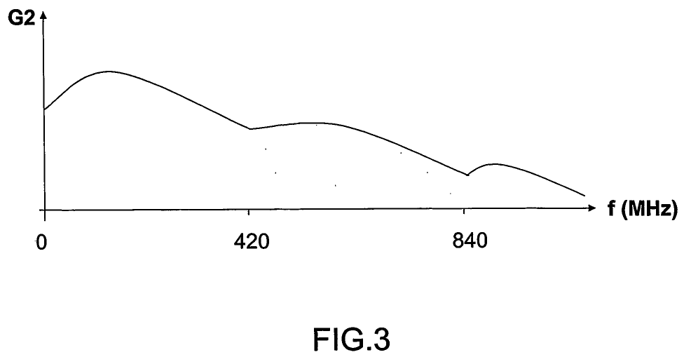

In parallel, the real gain of the selective filter 104 is determined by the means 121. The selective filter 104 indicates to the means 121 the value of the frequency channel X. A set of equations depending on the frequency range in which the frequency channel X is situated allows determining the real gain of the selective filter. The coefficients of this set of equations derive from a calibration previously made on the selective filter 104. A non-limitative example of such a set of equations is given below.
0<X<420 MHz−7,0258*10⁻⁸X⁴+5,0247*10⁻⁵X³−1,3011*10⁻²X²+1,1268^{*}X−30,8 Eq. 1
420<X<840 MHz−1,6317*10⁻¹¹X⁴+3,0699*10⁻⁷X³−4,9971*10⁻⁴X²+0,24851 ^{*}X−43,94 Eq. 2
X>840 MHz−6,3403*10⁻¹⁰X⁴+1,666*10⁻⁶X³−1,6353*10⁻³X²+0,70595^{*}X−122,85 Eq. 3
FIG. 3 illustrates the corresponding variations of the gain G2 of the selective filter 104.

By adding real gains of the amplifiers and the selective filter, the calculation means 122 determine the real total gain by which the input signal 101 has been amplified by the various amplifiers and filters arranged in series.

Preferably, the level of the output signal 108 and the gains of the amplifiers and of the selective filter are expressed in Decibels (dB) so that the level of the input signal 101 is obtained by simple subtraction of the level of the output signal 108 and the value of said real total gain.

For making a direct measurement in Decibels, the measuring means 116 comprise arranged in series:
a selective filter 117 for selecting said given frequency channel,
a logarithmic detector 118 for delivering an output value proportional to the logarithm of the signal present on its input,
an analog-to-digital converter 119 for delivering the level of said output signal in said given frequency channel.

For reducing the noise present in the output signal 108, for example due to the spectral noise, various successive measurements are made by the measuring means 116. Each of these measurements is for example temporarily stored, then an average of these measurements is calculated for delivering an averaged measurement of the output signal 108 in the given frequency channel containing a low noise level. Such an average of these values may be made, for example, by instruction codes executed by a signal processor.

For reducing measuring errors and for statistically increasing the precision in the level determination of an input signal 101, the level of the input signal is rounded to the nearest half value. These rounding may, for example, be made by instruction codes executed by a signal processor.

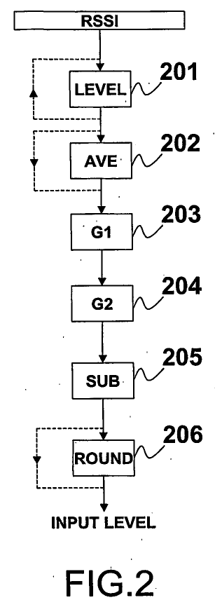

FIG. 2 represents the flow chart of the steps of the method according to the invention for determining the level of the input signal 101 applied to a receiving system represented in FIG. 1. This method comprises:
a measuring step 201 for measuring the level of the output signal 108 in a given frequency channel. This measuring step is repeated several times consecutively if an average value of this output signal is desired.
a calculation step 202 for calculating the average of the set of values measured in step 201,
a processing step 203 for determining from a look-up table the real total gain G1 of the set of amplifiers. The real total gain corresponds to the addition of real gains of each amplifier.
a first calculation step 204 for determining the real gain G2 of the selective filter 104 from a set of equations depending on the frequency channel,
a second calculation step 205 for deriving the level of the input signal 101 from the gains G1 and G2, and from the level of the output signal 108 measured during the step 201. If the gains and the level of the output signal are expressed in Decibels, the calculation step 205 consists of subtracting the gains G1 and G2 from the level of the measured signal 108.
a step 206 for rounding the level of the input signal 101 determined by the step 205 to the nearest half value.

The signal which is generated by the device or the method according to the invention corresponds to the determined level of the input signal. This signal is sent to service provider. This signal implicitly comprises technical characteristics of said device and method according to the invention.

The invention is not restricted to the measurement of the level of an input signal applied to a tuner receiving system as described in FIG. 1. Indeed, the device and the method according to the invention may also be implemented in a receiving system comprising a different number of amplifiers and selective filters. Similarly, the selective filter may be determined by a set of equations comprising a different number of equations depending on the frequency channel, the equations being defined by coefficients that can be recalibrated to take specific characteristics of the selective filter into account.

The device according to the invention may be implemented in any receiving system comprising an RSSI functionality for measuring and sending to a service provider, the level of the input signal applied to its input. For example, the device according to the invention can be implemented in a set top box comprising a tuner for receiving multimedia signals or a cable modem comprising a tuner.

1. Device for determining the level of an input signal (101) intended to be applied to a receiving system (TUN), said receiving system (TUN) comprising arranged in series a set of discrete gain amplifiers (102-103-105-107), a selective filter (104), a mixer (106), said receiving system (TUN) being intended to deliver an output signal (108), said device comprising:
measuring means (116) for measuring the level of said output signal (108) in a given frequency channel,
means (120) for determining the real gain (G1) of said set of amplifiers (102-103-105-107) in said given frequency channel,
means (121) for determining the real gain (G2) of said selective filter (104) in said given frequency channel,
calculation means (122) for deriving the level of the input signal (101) from the level of the output signal (108), the real gain (G1) of said set of amplifiers (102-103-105-107) and from the real gain (G2) of said selective filter (104).

2. Device as claimed in claim 1 where the real gain (G2) of said selective filter (104) is given by a set of equations defined by a set of coefficients depending on said frequency channel.

3. Device as claimed in claim 2 comprising additional means for averaging the level of said output signal (108).

4. Device as claimed in claim 3 comprising additional means for rounding the level of said input signal (101) to the nearest half value.

5. Device as claimed in claim 4 where the real gain (G1) of said set of amplifiers (102-103-105-107) is given by a look-up table with two inputs, a first input corresponding to said given frequency channel, a second input corresponding to the nominal gain of said amplifiers.

6. Device as claimed in claim 5 where said measuring means (116) comprise arranged in series a selective filter (117) for selecting said given frequency channel, a logarithmic detector (118) and an analog-to-digital converter (ADC) for delivering the level of said output signal (108) in said given frequency channel.

7. Method for determining the level of an input signal (101) intended to be applied to a receiving system (TUN), said receiving system (TUN) comprising arranged in series a set of discrete gain amplifiers (102-103-105-107), a selective filter (104), a mixer (106), said receiving system (TUN) being intended to deliver an output signal (108), said method comprising:
a measuring step (201) for measuring the level of said output signal (108) in a given frequency channel,
a processing step (203) for determining the real gain (G1) of said set of amplifiers (102-103-105-107) in said given frequency channel,
a first calculation step (204) for determining the real gain (G2) of said selective filter (104) in said given frequency channel,
a second calculation step (205) for deriving the level of the input signal (101) from the level of the output signal (108), from the real gain (G1) of said set of amplifiers and from the real gain (G2) of said selective filter (104).

8. Receiving box for multimedia signals, or modem comprising a device as claimed in claim 1.

9. Signal generated by the method as claimed in claim 7, said signal indicating the level of the input signal (101).

10. Computer program comprising instruction codes for executing one or a plurality of steps of the method as claimed in claim 7.
